(19) United States
(12) Patent Application Publication
(10) Pub. No.: US 2010/0096456 A1
(43) Pub. Date: Apr. 22, 2010

(54) INTRODUCED IN MAGNETIC CARD READER WITH PROTECTION AGAINST THERMAL AND EXOTHERMIC CHEMICAL ATTACK, AND ASSEMBLY PROCESS

(76) Inventor: Wagner Dias Rodrigues, Sao Bernardo Do Campo (BR)

Correspondence Address: John Alumit, 16830 Ventura Blvd. Suite 360, Encino, CA, 91436, US

(21) Appl. No.: 12/603,221

(22) Filed: Oct. 21, 2009

(30) Foreign Application Priority Data
Oct. 22, 2008 (BR) PI 0805784-2

(51) Int. Cl. G06K 7/00

(52) U.S. Cl. 235/439

(57) ABSTRACT

Improvements introduced in magnetic card reader with protection against thermal and exothermic chemic attack and in the assembly process. The improvements are specifically developed with a view to reducing the final cost of the product while protecting against thermal and exothermic chemical attack with the use of sensor circuits. The improved magnetic card reader and assembly process are designed in a way to protect information and secret processes, stored by electronic means, against unauthorized access.

### CROSS-REFERENCE TO RELATED APPPLICATION

This application claims the benefit of the priority filing date in Brazilian Patent Application No. PI 0805784-2 filed on Oct. 22, 2008.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention deals with improvements introduced in a magnetic card reader with protection against thermal and exothermic chemical attack. The improvements were specifically developed with a view to reducing the final cost of the product, while equipping it high security sensor circuits with protection against thermal and exothermic chemical attack. The improvements were developed in a way as to protect information and secret processes stored by electronic means against unauthorized access.

TECHNICAL BASIS. As is known, Points of Sale terminals (POS, PDV, PINPAD, encrypted keyboard) allow clients to pay their bills using several payment methods, such as credit cards, debit cards, smart cards etc. To guarantee that payment information transmitted from one of the sales point terminals to the payment center is not intercepted, such information is normally encrypted and protected during transmission, using, for example, digital authentication technology.

However, the confidential payment information keyed in by the user at a Point of Sale terminal could still be intercepted by a physical violation of the Point of Sale terminal.

Known is a technical method of impeding such interception and any violation of the magnetic card reading device, in which a magnetic head is assembled in a way to protect the reader contacts, therefore impeding access to these contacts. This protection is achieved by enveloping the magnetic head terminals with a malleable printed circuit, further enveloped in a chemical resin, in such a way as to mechanically protect the terminals so that they are totally inaccessible from external attacks.

The mentioned malleable printed circuit has several electronic layers on top of each other with the outermost layers having a random mosaic electronic circuit that, when broken or perforated, are detected by specialized security circuits. The protected innermost layers transmit on the trace electrical signals of the magnetic head terminals. A break in any part of the malleable tape of the circuit, in an attempted system invasion, causes the security circuit to activate.

Assembled on the inner face of the malleable printed circuit are security circuits with temperature sensors that detect thermal variations in the magnetic head. These temperature sensors are connected to the electronic security circuit of the malleable printed circuit with solder, which reacts to any thermal variation by changing its electrical impedance. This change in impedance should be monitored by an external security circuit which should be connected to the magnetic head reader. The change in impedance should set off a security response, activating an alarm or destroying stored information.

The solution already presented in the prior art also guards against mechanical attacks performed by cutting and perforating the magnetic head and the malleable tape circuit. This is done by using a random electronic mesh that is connected to the security circuit which detects any attempt at mechanical attack. The attempt to mechanically remove the thermal sensors also causes an impedance change.

Most solutions only protect the magnetic head circuit against mechanical attacks of the perforation or mechanical breaking type, but do not protect against thermal or exothermic chemical processes which seek to break through the resin without damaging the security circuits. In these systems, a physical envelope around the circuit terminals, in the form of a mesh, prevents access to the terminals using a constant electric current which detects any interruption of this current whenever there is a break in the protective mesh. However, this method is flawed in that an invader can remove the protective resin using thermal or exothermic chemical processes without mechanically damaging the protection mesh, thus obtaining access to the terminals without triggering the sensor. In other words, the premise that thermal or exothermic chemical attacks inevitably cause a mechanical break of the protective meshes is not valid.

Other than the current protection systems which is flawed, heads with SMD type terminals are also used, but are expensive.

### BRIEF DESCRIPTION OF THE INVENTION

Stemming from an analysis of the prior art concept, the proposed improvement is a technical innovation with protective resources that impede unauthorized access of circuits inside the Point of Sale terminal at reduced costs.

With the improvement proposed in this patent, a significant increase in security is obtained featuring, besides mechanical protection, a dynamic temperature monitoring system inside the magnetic head whose transducer will vary with impedance and which will be monitored by an electronic security circuit.

It is the premise of this invention that the magnetic card reader is connected to a an overall security system for the Point of Sale Terminal devices that increases the protective effectiveness concept applied to the device, and that a surveillance process encrypts information and secret processes in which the encryption keys used in the process are first destroyed if a violation event is detected by the monitoring circuit.

The proposed solution uses the magnetic head terminations with through-hole type contacts, which are cheaper compared to the SMD type, characterizing the system as low cost.

The proposed solution to detect a thermal and/or exothermic chemical attack uses passive semiconductor devices integrated into the protective electronic mesh. These are soldered in a protected form on the inner surface of the circuit in malleable tape, such that, with a temperature increase, the semiconductor device will signal the change in its conductivity and will be interpreted by the security circuit as an attack. The thermal and/or exothermic attack characterized by the phenomenon of a temperature increase will be detected as an attack on the terminal.

### SUMMARY

The invention comprises an improved magnetic card reader with protection against thermal and exothermic chemical attack comprised of a device of the type applied in a magnetic card assembly having a magnetic card cardan-type support, a magnetic card reader assembled on a spring, and a malleable tape circuit. The device is comprised of a magnetic head encapsulated in a metallic envelope filled with resin, with through-hole terminals accessible from the face, and which can be opened by an access door integrant of the metallic envelope. The malleable tape circuit is in the form of multi-layered malleable tape which carries collected signals in magnetic head terminals to a main circuit a Point of Sale Terminal. It is soldered on the through-hole type terminals of the magnetic head. Its outer layers have fine conducting pathways, or traces, on the whole surface distributed in random form and very dense, in the form of a coil. The endings of the traces are connected to a security circuit that monitors any breakage through a microprocessor.

The circuit also comprises two temperature sensors, soldered to thermal detection security traces of the circuit, which are passive semiconductor devices capable of changing their impedance in proportion to the temperature applied on their bodies. The sensors reach certain pre-defined limits identified as thermal attacks, they activate a security system circuit.

The process of assembling the improved magnetic card reader involves the magnetic head and the thermal sensors receiving the overlap of the malleable tape circuit, which is folded on the terminals of the magnetic head and on the referred to thermal sensors, depositing protective chemicals on the malleable tape circuit making them externally inaccessible and therefore inviolable, and inserting the magnetic head assembly in an envelope.

### FIGURES

FIG. 1 illustrates the external perspective view of a magnetic card reader assembly, where in view is the magnetic card cardan-type support, the magnetic card reader assembled on a spring and with the respective circuit in malleable tape, being the prior art concept;

FIG. 2 illustrates a rear view of the magnetic head assembly, where there are the electrical connections. In this illustration, the through-hole type terminals can be seen with the respective circuit in malleable tape before it is enveloped, and with the temperature sensors assembled on the inner face of the circuit in malleable tape;

FIG. 3 illustrates a rear view of the final magnetic head assembly where the sequence of circuit folds in malleable tape is seen already closed, protecting the security circuits;

FIG. 4 illustrates the operational flowchart of the violation detector circuit.

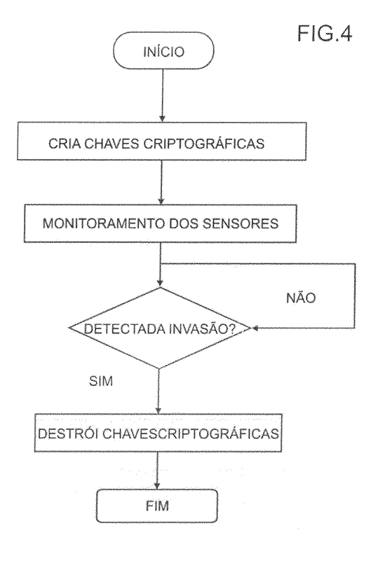

### DESCRIPTION

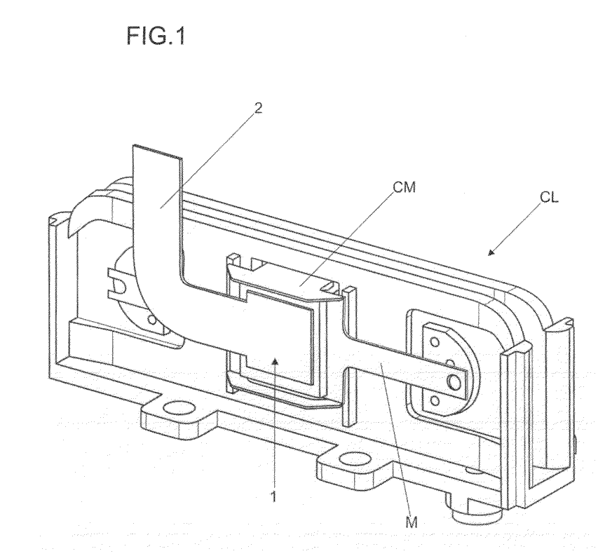

In conformity with the illustrated figures mentioned above, the object of the present invention consists of “IMPROVEMENTS INTRODUCED IN MAGNETIC CARD READER WITH PROTECTION AGAINST THERMAL AND EXOTHERMIC CHEMICAL ATTACK AND ASSEMBLY PROCESS”, said device (1) being of the type applied in a magnetic card reader assembly (CL). In FIG. 1, the magnetic card cardan-type support (CM) can be seen, the newly innovated magnetic card reader (1) assembled on a spring (M) and with the respective malleable tape circuit (2).

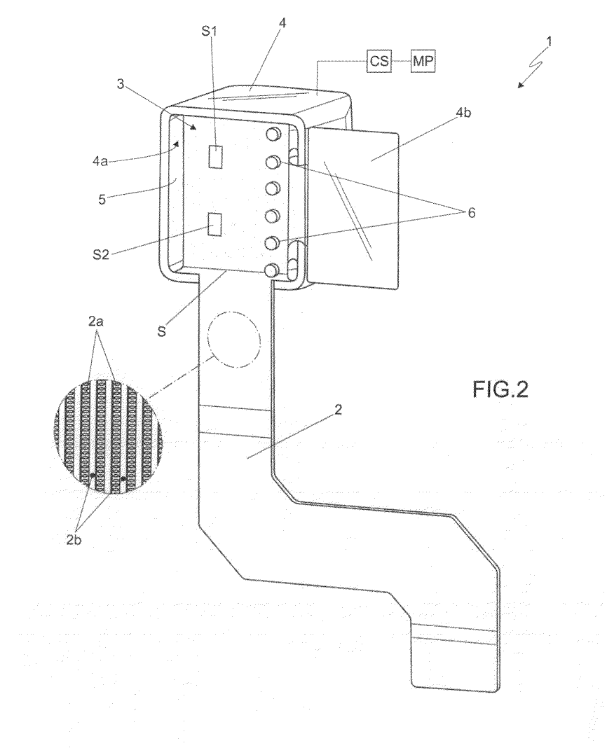

In accordance with the present invention, FIG. 2 generally indicates the magnetic head device (1) with mechanical protection and a sensor for thermal and exothermic chemical attack, comprising a magnetic head (3) encapsulated in a metallic envelope (4), filled with resin (5), with through-hole terminals (6) accessible from the face (4a) which can be opened by an access door (4b), integrant of the metallic envelope (4).

Also in FIG. 2, the circuit in multi-layered malleable tape (3) has the basic function of carrying the collected signals in the magnetic head terminals (3) to the main circuit of the Point of Sale Terminals (not illustrated); the tape (2) is soldered (S) on the through-hole type terminals (6) of the magnetic head (3). The carrying of the collected signals is made in the more inner layers of the malleable tape circuit (2), making it impossible to directly access these signals, unless they break the outer layers of the malleable tape circuit.

Sill referring to FIG. 2, the outer layers of the multi-layered malleable tape circuit (2) are protected on the whole surface by fine conducting pathways (2a and 2b) distributed in random form and very dense, in the form of coils as illustrated in the exploded view. The ends of these pathways, or traces, (2a and 2b) are connected to the security circuits (CS) which monitor any breakage through the microprocessor (MP). In this way, if there are attempts to mechanically peel off the outer circuit to access the inner traces (2b), the outer protective traces (2a) will break and activate the security system.

The same occurs if there is an attempt to mechanically perforate the outer layers to access the inner traces (2b), which would cause one or more protection traces (2a) to break.

Also in FIG. 2, the two temperature sensor devices (S1) and (S2) can be seen assembled on the malleable tape circuit and soldered to the thermal detection security traces (not illustrated). These passive semiconductor devices change their impedance in proportion to the temperature applied on their bodies. The thermal detection security traces should be connected to an electronic circuit inside the magnetic head (3) which monitors this impedance. When the temperature sensor devices (S1) and (S2) reaches limits defined as thermal attacks, they activate the security system circuit.

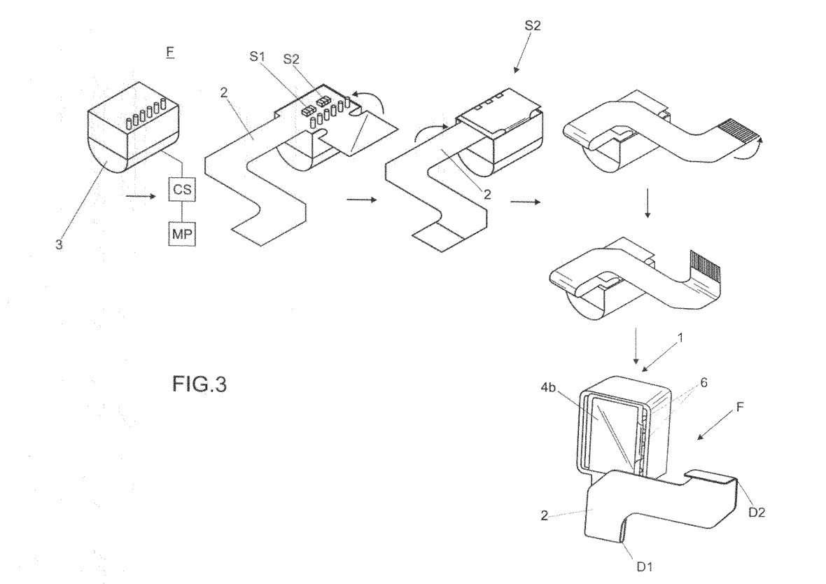

FIG. 3 shows the enveloping process of the device, whose stages follow the following steps: the magnetic head (3) and the thermal sensors (S1) and (S2) receive the overlap of the malleable tape circuit (2), which is folded on the terminals (6) of the magnetic head (3) and on the referred to thermal sensors; protective chemical resins are deposited on this circuit in malleable tape (2), making them externally inaccessible and therefore inviolable; the magnetic head (3) assembly is inserted in the envelope (4).

The functioning occurs in the following form: when detecting an invasion of the secure area, the security system circuit, outside the magnetic card reader device (1), activates the sensor (S1) which communicates to the microprocessor (MP) which in turn activates and destroys all the security keys (CS) that encrypt the secret information stored in the electronic memory. Without the security keys, it is not possible to recuperate secret information from the memory and carry out secret processes, thereby making the equipment inoperable.

Inside the microprocessor there is a true random number generator. The random numbers of this generator are used to create signal forms of amplitude, frequency and phase parameters for the sensors. These signals pass through the sensor group and return to the microprocessor, whose comparing circuits check the referred parameters of the original signals. Detecting differences in the parameters, the invasion alarm circuit is activated, and immediately, secret information is destroyed, turning the equipment inoperable and making it impossible to recuperate the information.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved magnetic card reader with protection against thermal and exothermic chemical attack comprised of a device of the type applied in a magnetic card assembly having a magnetic card cardan-type support, a magnetic card reader assembled on a spring, and at least one malleable tape circuit, characterized by the fact that
(A) the device is comprised of a magnetic head encapsulated in a metallic envelope filled with resin, with through-hole terminals accessible from the face, which can be opened by an access door integrant of the metallic envelope,
(B) the circuit is in the form of multi-layered malleable tape which carries collected signals in magnetic head terminals to a main circuit of at least one Point of Sale Terminal,
(i) is soldered on the through-hole type terminals of the magnetic head,
(ii) the outer layers of the circuit in multi-layered malleable tape having fine conducting pathways, or traces, on the whole surface distributed in random form and very dense, and in the form of a coil, the endings of which are connected to at least one security circuit which monitors any breakage through a microprocessor,
(iii) the circuit further comprising at least two temperature sensors assembled thereon and soldered to thermal detection security traces of the circuit,
(a) the temperature sensors, being passive semiconductor devices, are able to change their impedance in proportion to the temperature applied on their bodies.

2. A process of assembling the improved magnetic card reader of claim 1, characterized by the fact that the device enveloping process follows the following steps:
(A) the magnetic head and the thermal sensors receives the overlap of the malleable tape circuit, which is folded on the terminals of the magnetic head and on the referred to thermal sensors;
(B) protective chemical resins are deposited on the malleable tape circuit making them externally inaccessible and therefore inviolable;
(C) the magnetic head assembly is inserted in an envelope.

3. The improved magnetic card reader of claim 1 characterized in that the collected signals are carried in the inner layers of the malleable tape circuit.

4. The improved magnetic card reader of claim 1 characterized in that the outer layers of the circuit activate a security system when broken, including in an attempt to mechanically unpeel the outer layers.

5. The improved magnetic card reader of claim 1 characterized in that the outer layers of the circuit activate a security system when mechanically perforated in an attempt to reach the inner traces.

6. The improved magnetic card reader of claim 1 characterized in that the thermal detection security traces are connected to an electronic circuit inside the magnetic head which monitors the impedance of the at least two sensors, which in turn activates a security system circuit when the at least two sensors reach pre-defined limits identified as thermal attacks.
